(19) United States
(12) Patent Application Publication
(10) Pub. No.: US 2006/0059133 A1
(43) Pub. Date: Mar. 16, 2006

(54) Hyperlink generation device, hyperlink generation method, and hyperlink generation program

(75) Inventor: Keisuke Moritani, Nagoya (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/204,224

(22) Filed: Aug. 16, 2005

(30) Foreign Application Priority Data
Aug. 24, 2004 (JP) 2004-243979

(51) Int. Cl. G06F 17/30; G06F 15/173

(52) U.S. Cl. 707/3; 709/224

(57) ABSTRACT

In the prior art it has not been possible to guide a user to a web page intended by an administrator without identifying the user. A link generation device is provided which is used by being connected to a web server which, in response to page acquisition requests from client terminals, transmits data to display the relevant web page on the screen of the client terminal. The link generation device has a storage unit which stores important keywords set in advance for each web page, and extracts the search expressions used when web pages on the web server are accessed via a search engine site. When a search expression used to access a certain web page is the important keyword of another web page, the link generation device adds a hyperlink guiding users to the other web page, to the web page file written in markup language, corresponding to the certain web page.

### BACKGROUND OF THE INVENTION

1. Field of the Invention

This invention relates to a hyperlink generation device which adds hyperlinks to a file for display of a web page, written in HTML (HyperText Markup Language), SGML (Standard Generalized Markup Language), XML (extensible Markup Language), CHTML (Compact HTML), or another markup language, and in particular relates to a hyperlink generation device which generates hyperlinks in order to guide a user to an appropriate web page.

2. Description of the Related Art

Currently a variety of web pages are being created for public display via the Internet by both individuals and corporations, and various types of information are being transmitted. An ordinary web page is one portion of a web site, which is constructed from a plurality of web pages organized along a certain theme; a web page is made of at least one web page file, written in HTML or some other markup language.

Each web site is managed by an administrator; the administrator updates the contents of a web page by updating the contents of a web page file and uploading the web page file to the server. The server is realized by an information terminal on which a web server program is installed, or by a dedicated terminal or similar which realizes the functions of the web server program in hardware. This web server program transmits the data of the page in response to a page acquisition request from a client terminal (PC (Personal Computer), PDA (Personal Digital Assistant), portable telephone, or other information terminal) connected via a network.

A very large amount of information is transmitted by these web pages, and in order to acquire information useful to oneself, a user frequently visits a web site of the type generally known as a search engine site. At a search engine site, upon providing a search expression, hyperlinks to web pages corresponding to the search expression are displayed as a list, and by clicking a hyperlink of interest, the user can cause the relevant web page to be displayed. Normally the user starts browsing by using hyperlinks in the top page of a web site to the desired web page, moving between web pages (in other words, switching the displayed web page); but if a search engine site is used, direct access to the desired web page becomes possible.

Further, in order to present to a user with selected information from among a vast amount of information, technologies to guide a user to a prescribed web page have for example been proposed in Japanese Patent Laid-open No. 2003-256470, Japanese Patent Laid-open No. 2002-24270, and Japanese Patent Laid-open No. 2003-91477. In such example of the prior art, when guiding a user, the user viewing a certain web site is identified, and based on a viewing history (access log) for the user, movement by the user within the web site is analyzed. The analysis results are referenced to derive a user profile, including the user viewing state, preferences and similar, and the appropriate web page is displayed according to this user profile.

### SUMMARY OF THE INVENTION

However, in the examples of the prior art, although a user is guided based on the user viewing state, preferences, and other aspects of a user profile, the intentions of the web site administrator are not reflected in this process. For example, there are cases in which a web page managed by a certain administrator and included in a list displayed as the search results for input of a search expression at a search engine site, and a web page which the certain administrator would want to present to the user when the search expression is input, are not the same. Because the methods used to control web pages presented in lists at search engine sites (for example, methods used to cause one's own page to appear at the top of a list, and to be clicked on more frequently) are not generally made public, an administrator without a knowledge to execute these methods cannot guide a user employing a search engine site to the web page intended by the administrator.

That is, as a result of use of a search engine site, the user initially views only sub-pages, which are displayed at the top of the search result list and are of lower importance than the main page, which the administrator wants the user to view. The user clicks on a hyperlink within the initial page to move to another page (that is, to switch the display to another page), but if the user glances over the initial page and does not become interested, often he/she may leave the web site and view another web site instead, so that the information (presented on the main page) which is of great importance for the administrator is never seen by the user, and remains undiscovered.

Also, in the above examples of the prior art the user must be identified as a premise for guiding the user to the desired page, but if the user cannot be identified appropriately, an erroneous user profile may be derived, and it is difficult to guide an unidentified user. For example, the user cannot be appropriately identified, if the user may be identified using only the IP (Internet Protocol) address, which identifies the information terminal which is the source of the access, and is contained in the access log.

This non-identification also occurs when the user is using a proxy server. When a proxy server is used, the IP address of the information terminal used by the user is not transmitted to the web server; rather, access by a plurality of information terminals is concentrated into access from the same IP address (that of the proxy server). Hence even if there is access from the same IP address recorded in the access log, the access may not be by the same user, and appropriate identification of the user is not possible. Further, in cases where a single information terminal is shared by a plurality of users, and in cases where an IP address is dynamically allocated to an information terminal, accesses from the same IP address recorded in the access log may not be by the same user.

In such cases, if authentication based on an account name, password or similar is also employed, the user can be appropriately identified; but because advance user registration is necessary, administrators wishing to avoid user access processing to be complex, and administrators of web sites for which there is no particular need to limit access often do not adopt an authentication method, and consequently an unidentified user cannot be guided to the web page intended by the administrator.

Hence an object of this invention is to provide a hyperlink generation device which generates hyperlinks to guide a user visiting a certain web site to another web page, without identifying the user accessing the web site.

According to a first perspective of this invention, the above object is attained by providing a link generation device, which generates link locations of information sought by users, and is characterized in having a search information extraction unit, which extracts search information from search operation information which records search operations performed by users; a guide link generation judgment unit, which judges whether a new link location can be generated, based on said search information; and a link generation unit, which, when said guide link generation judgment unit judges that a new link location can be generated, generates the new link location

In a preferred mode of the above perspective of the invention, the above search information extraction unit stores the history of the above search information, and the above guide link generation judgment unit performs the above judgment based on the above history of search information. In a preferred mode of the above perspective of the invention, the above search information extraction unit stores the number of occurrences of the above search information received with page acquisition requests to web browser, and the above guide link generation judgment unit uses in the above judgment, the search information the number of occurrences of which exceeds a prescribed threshold.

In a preferred mode of the above perspective of the invention, the above guide link generation judgment unit may perform the above judgment based on tags embedded in information stored at link locations. In a preferred mode of the above perspective of the invention, the above search operation information is an access log generated by a search device.

According to a second perspective of this invention, the above object is attained by providing an information generation device, which generates information specified by a user, and is characterized in having a search information extraction unit, which extracts search information from search operation information which records the search operations performed by the user; a guide link generation judgment unit, which judges whether it is possible to generate a new link location, based on the above search information; and a link generation unit, which, when the above guide link generation judgment unit judges that a new link location can be generated, generates the new link location.

In a preferred mode of the above second perspective of the invention, the above information generation device has a communication unit, connected to a communication network, which performs communication via the communication network.

According to a third perspective of this invention, the above object is attained by providing a link generation method, to generate link locations for information sought by a user, and which is characterized in having extracting search information from search operation information which records search operations performed by users; judging whether a new link location can be generated, based on above search information; and generating the new link location when in above judgment it is judged that a new link location can be generated.

Further, the above object can be attained by providing a storage medium having a program which is characterized in causing a computer to execute: extracting search information from search operation information which records the search operation performed by users; judging whether a new link location can be generated, based on said search information; and generating the new link location when in said judgment it is judged that a new link location can be generated.

By means of these aspects, hyperlinks can be added to a web page which is frequently accessed through a search expression differing from “important keywords” set in the web page, guiding the user to a web page which the web site administrator desires a user to view when the search expression is input. And by this means a user accessing the web site can be guided to the web page intended by the web site administrator, without identifying the user by means of authentication processing or similar. Because there is no need to identify the user, the log recording functions of the web server can be utilized without modification, and a link generation device can be easily introduced. Because the functions of the link generation device can also be realized as a program, the program can be installed on the web server to execute link generation function in a single device, thereby reducing costs and administrative tasks.

### BRIEF DESCRIPTION OF THE DRAWINGS

FIG. 1 shows the configuration of an information system of an aspect of the invention;

FIG. 2 explains the structure of an example of a web site constructed on a web server, using examples of screens displayed on a client terminal;

FIG. 3 is a block diagram of the configuration of a client terminal, web server, link generation device, and search engine site server of the aspect;

FIG. 4 is a functional block diagram which explains the link generation device and web server in an aspect of the invention;

FIG. 5 is an example of the data configuration of an access log record stored in an access log database in the aspect;

FIG. 6 is an example of the data configuration of expression extraction information in the aspect;

FIG. 7 is an example of the data configuration of a totaled result database in the aspect;

FIG. 8 is an example of the data configuration of an important keyword database in which important keywords are associated for each web page in the aspect;

FIG. 9 is an example of the data configuration of a frequently occurring expression database in the aspect;

FIG. 10A shows an example of a web page file prior to addition of a link in the aspect, and FIG. 10B shows an example of a web page file after addition of a link;

FIG. 11 is a flowchart which explains the operation of a link generation device in the aspect; and,

FIG. 12 explains the manner in which a user views a site A constructed on a web server in the aspect, using examples of screens displayed on a client terminal.

### DESCRIPTION OF THE PREFERRED EMBODIMENTS

Below, aspects of the invention are explained, based on the drawings. However, the technical scope of this invention is not limited to these aspects, but extends to inventions equivalent to those described in the scope of claims.

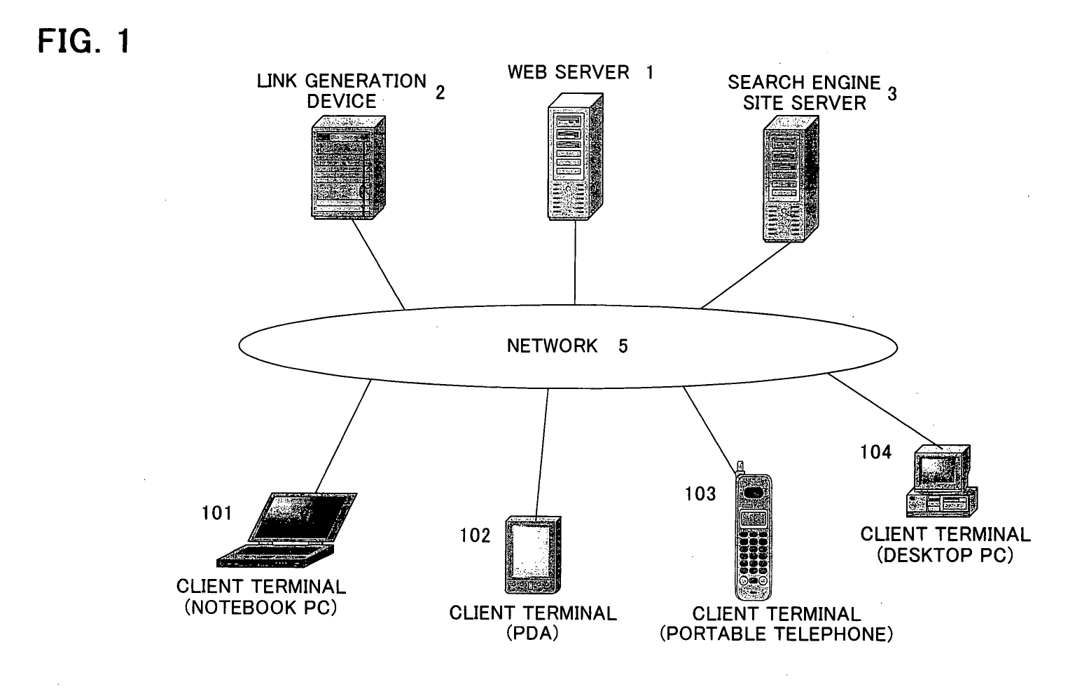

FIG. 1 shows the configuration of an information system of an aspect of the invention. The plurality of client terminals 101 through 104, the web server 1 which provides web pages to client terminals, the search engine site server 3 used for searching of web pages, and the link generation device 2, are connected via the network 5. In aspects of this invention, the link generation device 2 analyzes, for each web page, what search expression was input when a user accesses a web page provided by the web server 1 via the search engine site server 3, and adds hyperlinks to the web page for guiding the user to other appropriate web pages according to the analysis results; by this means, the user is guided to a web page reflecting the intention of the web site administrator.

A web site is formed on the web server 1 by a plurality of web pages; the web site is accessed when a user specifies an URL (Uniform Resource Locator) for web page viewing software (a web browser) installed on the client terminals 101 through 104. Each URL is address information which identifies the location at which a web page file is stored.

A web page file contains format data and content text data and similar which is written in HTML (HyperText Markup Language) or another markup language. A web page file can also include embedded links, called hyperlinks, which are used to acquire web page files with image data, audio data, text data, and similar, stored at a location different from the storage location of the hyperlink-embedded web page file itself. When a hyperlink is displayed by means of a web browser, the user can obtain the data of the link location merely by clicking on the displayed hyperlink.

When a user starts up a web browser installed on one of the client terminals 101 through 104, which are connected to the web server 1 via the network 5, and specifies an URL of the web server 1, a page acquisition request is transmitted to the web server 1 to access a web page. The web server 1 transmits the data corresponding to the specified URL to the client terminal which had transmitted the page acquisition request, and also stores in an access log data relating to the access, such as the IP address of the client terminal, the designated URL (address information of the page acquired), and the URL of the web page which had been viewed immediately before the page acquisition request (the address information of the referring page).

If data transmitted to the client terminal is a web page file, the web browser arranges the content into the format specified using the markup language appearing in the web page file, and displays the content on the display unit, such as a liquid crystal display, equipped by the client terminal. If transmitted data is audio data or image data, the data is either played/displayed within the web browser by plug-in software of the web browser, or is played/displayed by software called by the web browser, or is stored without further action on the client terminal. By this means, a user views web pages and acquires various kinds of data.

Client terminals is composed of such information terminals as notebook PCs 101, PDAs 102, portable telephones 103, and desktop PCs 104. In addition, an information terminal capable of browsing web content can be employed as a client terminal. The network 5 may be a LAN (Local Area Network), WAN (Wide Area Network), the Internet, or similar.

When there exist a plurality of web servers 1 connected via the network 5, it is difficult for a user to determine the URLs of all web sites and the contents provided on all web sites. Hence in order to acquire necessary information, a user often employs a search engine site server 3, which when a search expression is provided, outputs information on web sites related to the search expression, to search for desired web pages.

The search engine site server 3 receives, via the network 5, a search expression input by a user to one of the client terminals 101 through 104, and collects, lists, and transmits to the client terminal the URLs of web sites related to the input search expressions, the titles of the web pages, simple explanations of the content thereof, and similar, either based on a database of the search engine site server prepared in advance, or according to an algorithm of the search engine site server. At this time, the URLs or titles in the list are presented as hyperlinks, and the user can cause a desired web page to be displayed merely by clicking on a hyperlink displayed on the client terminal.

An important keyword database (important keyword DB), in which “important keywords” set by the web site administrator are associated in advance with each web page stored on a web server 1, is stored in the link generation device 2. The important keywords for each web site are determined so as to be associated with a web page which the web site administrator wants a user to view when an important keyword is input to the search engine site server 3. For example, if “television” is input to a search engine site as a search expression, if there is a web page which the administrator of a web site wants the user to view, “television” is determined as an important keyword for this web page.

The link generation device 2 acquires the access log stored on the web server 1 with prescribed timing, and analyzes the information added as compared with the previous time of acquisition (the access log difference). When a user employs the search engine site server 3 to access the web server 1, the web page that had been viewed immediately prior to the page acquisition request is the page of the search engine site, and the the URL of the search engine site server 3 is stored as the address information of the referring page in the access log. This URL also contains the input search expression. Moreover, the address information of the page acquired in the access log identifies the web page which has been accessed.

Hence by comparing “important keywords” with the search expression used for access, it is possible to judge whether access has been according to the intentions of the web site administrator. That is, if the search expression used to access the web page matches important keywords, the intentions of the web site administrator have been reflected, and if not, the intentions of the web site administrator have not been reflected. For example, if as a result of a search by the search engine site using the search expression “television” a web page with the important keyword “DVD” is ranked higher than a web page with the important keyword “television”, so that the user views the “DVD”-related web page instead, then the access has not reflected the intentions of the administrator.

Hence when a search expression used to access a certain web page is an important keyword of another web page, a hyperlink linking to the another web page is added to that certain web page. By this means, the user can be guided to the web page which reflects the intentions of the web site administrator.

Next, a web site which employs this aspect of the invention is explained.

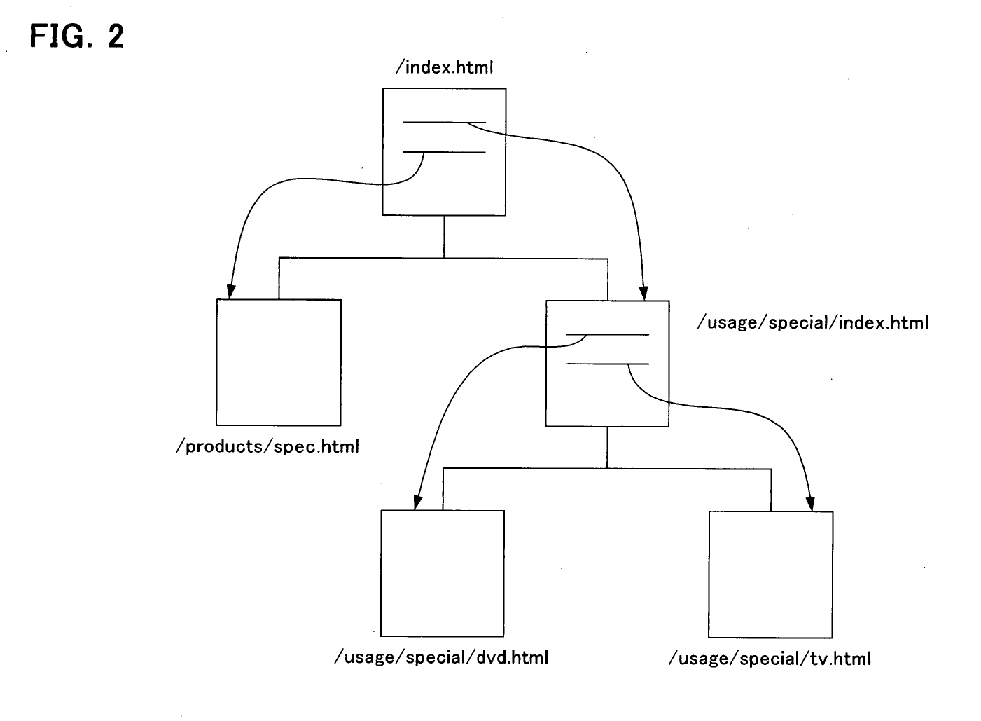

FIG. 2 explains the structure of an example of a web site constructed on a web server 1, using examples of screens displayed on a client terminal. In this aspect, the name of a web site constructed on the web server 1 is site A, the URL of which is http://sitea.aaa/. This site A is a site which introduces PC products, and describes the specifications and functions of PC products.

In the top page of site A (http://sitea.aaa/index.html) are embedded two hyperlinks; one is a link to an index page to explain functions (http://sitea.aaa/usage/special/index.html), and the other is a link to a page which explains specifications (http://sitea.aaa/products/spec.html). Further, on the index page which explains functions (http://sitea.aaa/usage/special/index.html) are embedded a link to a page explaining DVD creation functions (http://sitea.aaa/usage/special/dvd.html), and a link to a page explaining television recording functions (http://sitea.aaa/usage/special/tv.html).

When a user clicks on a hyperlink, the client terminal transmits to the web server 1 a page acquisition request for the URL corresponding to the link, and the client terminal then displays the page. Thus by clicking hyperlinks, a user can display successive web pages within a hierarchical web site constructed on the web server 1.

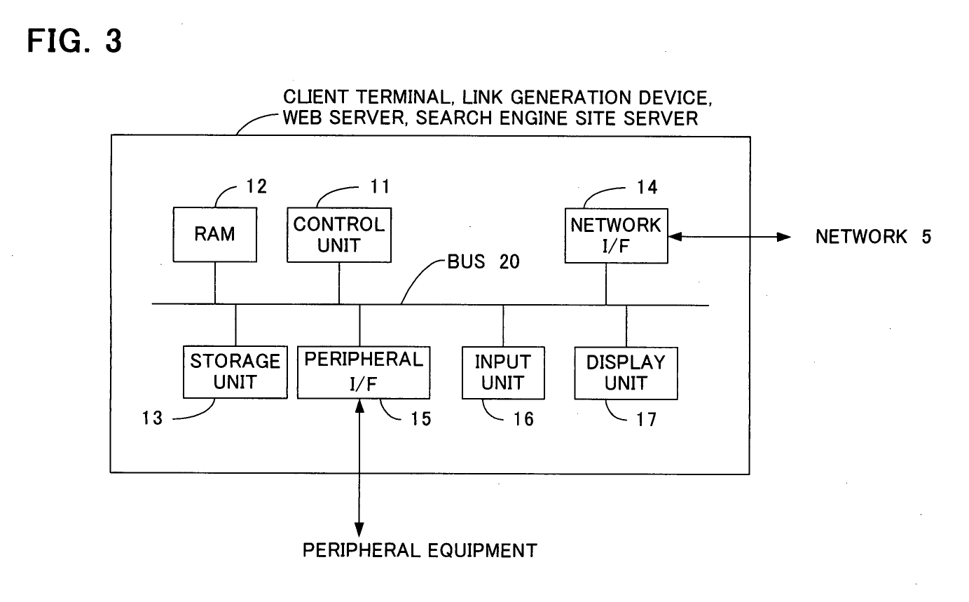

FIG. 3 is a block diagram of the configuration of the client terminals 101 to 104, web server 1, link generation device 2, and search engine site server 3 of the aspect. FIG. 3 gives an explanation for an example in which the client terminal is the notebook PC 101 of FIG. 1.

The notebook PC 101 has a control unit 11, RAM (Random Access Memory) 12, storage unit 13, network interface (I/F) 14, peripheral equipment connection interface (I/F) 15, input unit 16, and display unit 17, all interconnected via a bus 20.

The control unit 11 contains a CPU (Central Processing Unit), not shown, executes programs read into RAM, and controls the various units in the notebook PC 101. The RAM 12 is storage means in which are temporarily stored programs and computation results used in processing by the notebook PC 101. The storage unit 13 is a hard disk, optical disc, magneto-optical disc, flash memory, or other nonvolatile storage means, and stores various data and the OS (Operating System) and other programs before they are read to RAM.

The peripheral equipment I/F 15 is an interface to connect peripheral equipment to the notebook PC 101, and may be a USB (Universal Serial Bus) port, a PCI card slot, or similar. Peripheral equipment includes a large variety of devices, including printers, TV tuners, SCSI (Small Computer System Interface) equipment, audio equipment, memory card reader/writers, network cards, wireless LAN cards, and modem cards. In addition, peripheral equipment also includes a USB mouse connected externally via the peripheral equipment I/F 15, an externally connected projector for presentations, an external monitor, and similar.

Signals or data sent and received via the network 5 are input to and output from the network I/F 14. The network I/F 14 may be omitted if there is a network card, wireless LAN card, modem card, or other communication card, externally connected via the above-described peripheral equipment I/F 15.

The input unit 16 is an input device used to input the input signals for commands entered by the user from a keyboard, mouse, touchscreen, buttons, or similar to the notebook PC 101. The display unit 17 is a display device to display information on a liquid crystal screen, CRT (Cathode Ray Tube), or similar for the user.

In addition to the notebook PC 101 of FIG. 3, a PDA 102 and portable telephone 103 are also configured as a main unit including an input unit 16 and display unit 17 as in FIG. 3; but in the case of other client terminals (for example, a desktop PC 104), a web server 1, a link generation device 2, or a search engine site server 3, the keyboard or other input unit 16 and liquid crystal display, CRT or other display unit 17 may be externally connected via a peripheral equipment I/F 15.

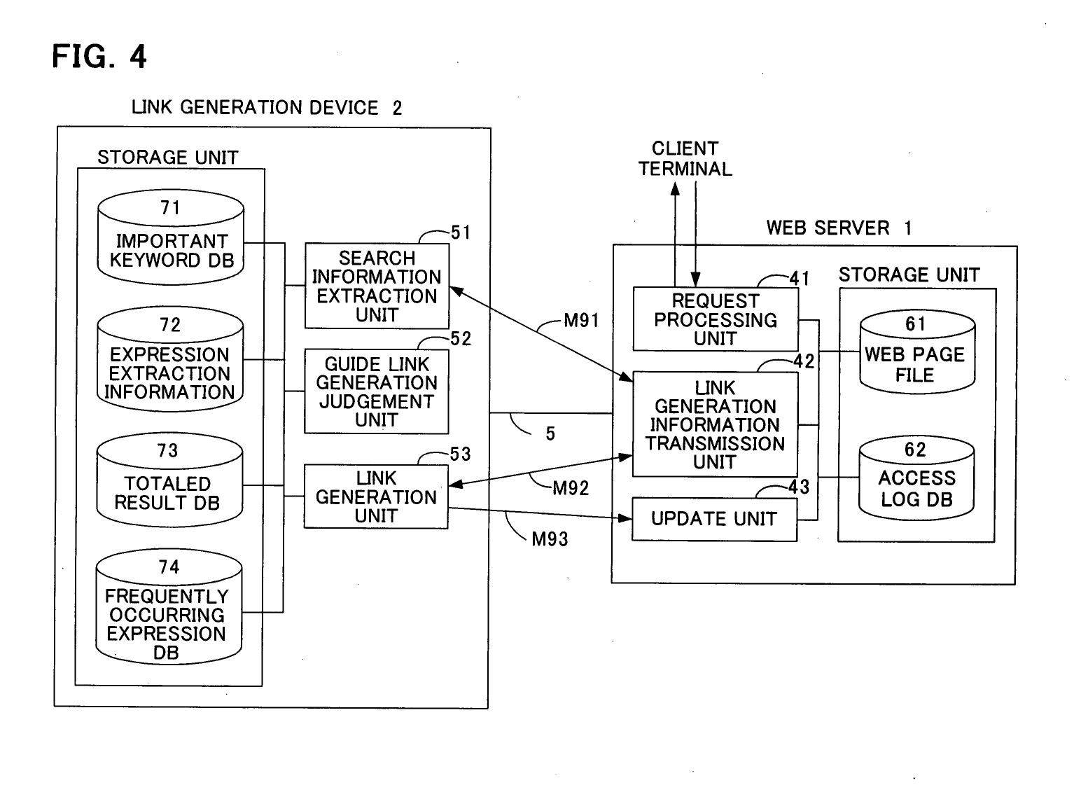

FIG. 4 is a functional block diagram which explains the link generation device 2 and web server 1 in an aspect of the invention. Each of the functional units in FIG. 4 can be realized either by hardware, or as a program executed by a CPU, not shown, in the control unit of the respective devices.

The web server 1 has a request processing unit 41, link generation information transmission unit 42, update unit 43, and storage unit. The storage unit of the web server 1 stores a plurality of web page files 61 and an access log database (access log DB) 62.

Upon receiving a page acquisition request transmitted from a client terminal, the request processing unit 41 reads from the storage unit the web page file 61 corresponding to the URL specified by the page acquisition request, and transmits the web page file 61 to the client terminal which had transmitted the page acquisition request. At this time, the request processing unit 41 stores prescribed information in the access log DB 62 as an access log.

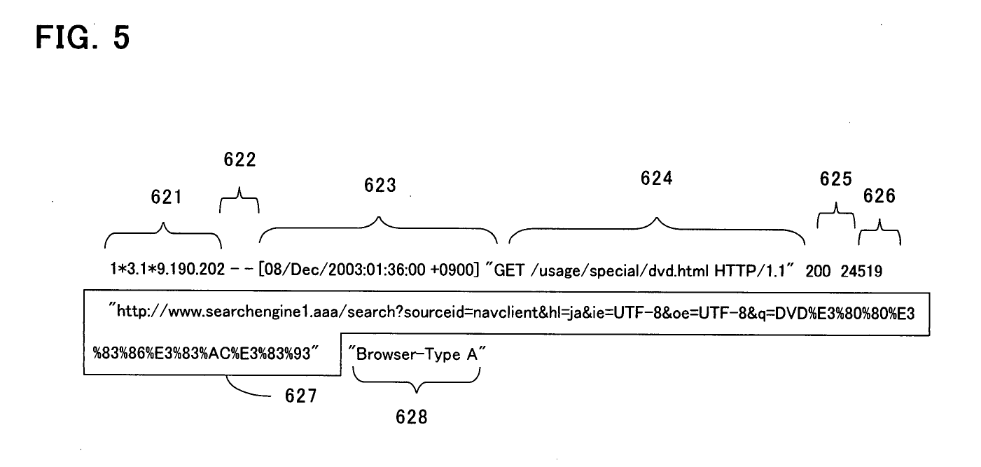

FIG. 5 is an example of the data configuration of an access log record stored in an access log DB in the aspect. A plurality of access log records such as that shown in FIG. 5 are stored in the access log DB 62, with a single line of data corresponding to a single access.

As prescribed information, the access log record of FIG. 5 includes the IP address 621 of the client terminal which had transmitted the page acquisition request; the time 623 at which the web server 1 finished processing the page acquisition request; the contents 624 of the request from the client terminal; the status code 625 returned to the client terminal by the web server 1; the size of the data transmitted to the client terminal, excluding the response header; the address information 627 of the referring page, called the referrer, reported by the client terminal; and information 628 relating to the web browser of the client terminal; The hyphen symbols 622 in FIG. 5 signify that the information requested could not be obtained; if it were obtained, the identifier of the client terminal and the user ID of the user issuing the page acquisition request would be stored. Asterisks (*) appear in parts of the IP address 621; in actuality, single digits would appear in these parts.

If the domain name of the address information of the referring page 627 (in FIG. 5, www.searchengine1.aaa) is analyzed, the web site which had been viewed by the user immediately before accessing the web server 1 can be identified; in particular, when this web site is a search engine site, the address information of the referring page contains the search expression used in the search. Further, address information of the web page acquired is included in the contents 624 of the request from the client terminal. Hence by analyzing the access log record of FIG. 5, it is possible to determine the search expression used to access the web page of the web server 1.

Here, a page acquisition request has been explained; but this is not the only type of request sent to the web server 1 for processing by the request processing unit 41. Each time there is some type of request sent to the web server 1 from a client terminal, an access log record similar to that in FIG. 5 is stored.

Returning to FIG. 4, the link generation device 2 analyzes the access log periodically, and the web server 1 periodically receives access log acquisition requests from the link generation device 2 (M91). In response to the access log acquisition request from the link generation device 2, the link information transmission unit 42 of the web server 1 then transmits the access log stored in the access log DB 62 during the period between the previous access log acquisition request and this access log acquisition request (differential data) (M91).

The link generation device 2 adds a guide link to a web page judged to require addition of a guide link, and so the web server 1 receives a file acquisition request from the link generation device 2 (M92). The link information transmission unit 42 of the web server 1 then transmits the web page file corresponding to the web page specified by the file acquisition request, in response to the file acquisition request from the link generation device 2 (M92).

The update unit 43 receives the web page file to which the guide link has been added from the link generation device 2 (M93), stores the web page file in the storage unit of the web server 1, and updates the corresponding web page.

On the other hand, the link generation device 2 has a search information extraction unit 51; guide link generation judgment unit 52; link generation unit 53; and storage unit. The storage unit of the link generation device 2 stores an important keyword database (important keyword DB) 71; expression extraction information 72; totaled result database (totaled result DB) 73; and frequently occurring expression database (frequently occurring expression DB) 74.

The search information extraction unit 51 periodically transmits access log acquisition requests to the web server 1 and receives the access log. Based on the address information of the referring page 627 in an access log, the expression extraction information 72 is referenced to determine whether the access of the web server 1 was access via the search engine site server 3, and in the case of access via the search engine site server 3, the search expression used is extracted.

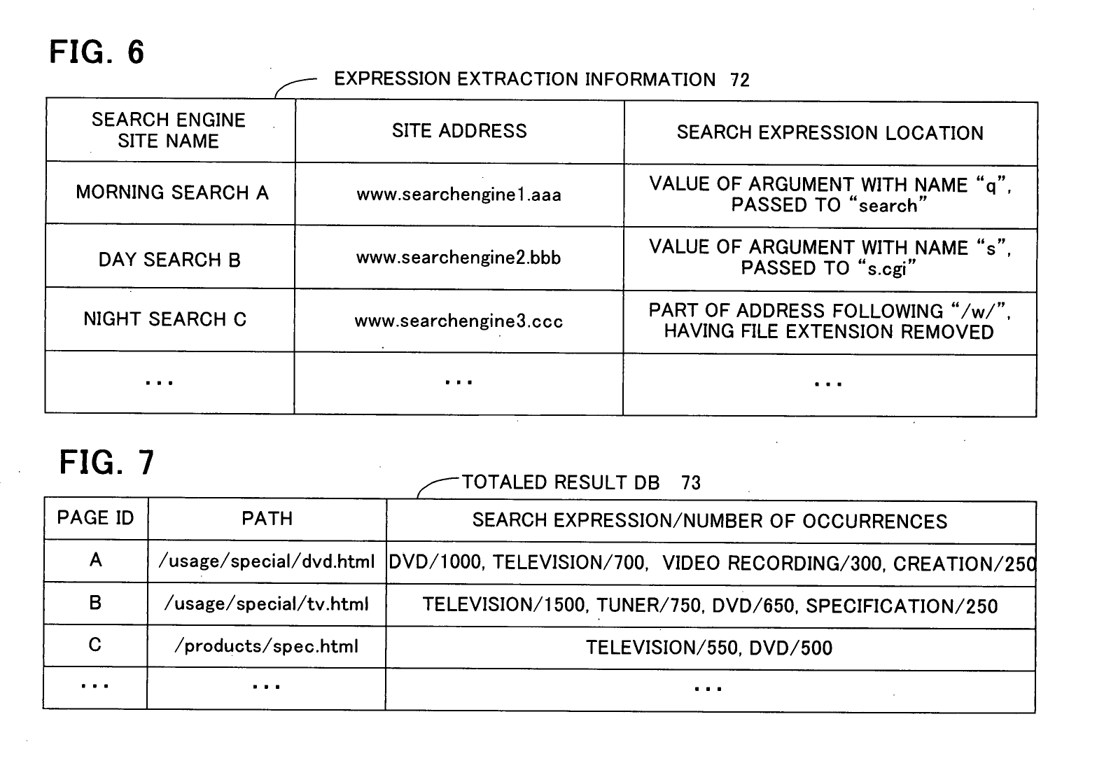

FIG. 6 is an example of the data configuration of expression extraction information 72 in this aspect. Expression extract information 72 is created in advance for each search engine site, and is stored in the storage unit of the link generation device 2. Expression extraction information is information needed to determine whether access of the web server 1 is access via a search engine site server 3, based on the address information of the referring page 627 in the access log, and if the access is via a search engine site server 3, to extract the search expression used. When a new search engine site is added, expression extraction information 72 related to the newly added search engine site is also added.

The expression extraction information 72 of FIG. 6 contains the data fields “search engine site name”, “site address”, and “search expression location”. “Search engine site name” is a name to identify the search engine site; “site address” is either the server name, or the domain name, or a combination of the server name and domain name, in order to identify the search engine site. If a character string used in the “site address” is included in the address information of the referring page 627 in the access log record, access corresponding to this access log record can be identified as access via the search engine site.

The “search expression location” is information used to extract the search expression input at the search engine site from the address information of the referring page 627 in the access log. For example, taking as an example the address information of the referring page 627 shown in FIG. 5, because the character string used in the “site address” in the first line of FIG. 6 (www.searchengine1.aaa) is present, it is seen that this access was via the search engine site “Morning Search A”. Referring to the “search expression location” in the first line of FIG. 6, it is seen that the search expression is the value of the argument with name “q” which is passed to the CGI (Common Gateway Interface) application “search”; in the example of FIG. 5, this is “DVD % E3%80%80% E3%83%86% E3%83% AC % E3%83%93”. This is an URL-encoded character string; upon URL decoding, “DVD” and “a word which means television in Japanese” can be extracted. That is, it is ascertained that what was input by the user at the search engine site as the search expression was the two words “DVD” and “television”.

The method of extracting the search expression included in the address information of the referring page 627 differs for each search engine site, but by referring to the “search expression location” in FIG. 6, the search expression can be extracted appropriately. In this way, the search information extraction unit 51 identifies access via a search engine site based on the address information of the referring page 627 in the access log record, and extracts the search expression used.

The search information extraction unit 51 acquires address information for a web page accessed via a search engine site server 3. This is acquired by referencing the address information of the page acquired in the contents 624 of the request from the client terminal. In the example of FIG. 5, when the request contents 624 from the client terminal are delimited by spaces, the continuous string following the GET command (/usage/special/dvd.html) is the acquisition location address information. The search information extraction unit 51 totals the results for each web page, including the search expression used to access the web page and the number of occurrences, and stores the totaled results in the totaled result DB 73.

FIG. 7 is an example of the data configuration of a totaled result DB in this aspect. The totaled result DB 73 in FIG. 7 contains the data fields “page ID”, “path”, and “search expression/number of occurrences”. The “page ID” is an identifier which uniquely identifies a web page, using alphanumeric characters and symbols. The “path” is address information indicating the storage location on the web server 1 of the web page file corresponding to a web page. In FIG. 7, the site address (sitea.aaa) is omitted.

The “search expression/number of occurrences” associates the terms used as a search expression when accessing a web page via a search engine site with the number of such accesses. For example, the web page (/usage/special/dvd.html), the page ID of which is A in FIG. 7, has been viewed as a result of input to a search engine site of the terms, listed in order from the greatest number of occurrences, “DVD”, “television”, “videorecording”, and “creation”. In this way, the tendencies for each web page to be accessed by different search expressions are clear from the totaled result DB 73 of FIG. 7.

Returning to FIG. 4, when the totaled result DB 73 is updated by the search information extraction unit 51, the guide link generation judgment unit 52 is notified of this updating, and based on the important keyword DB 71 which associates important keywords for each web page and the totaled result DB 73, the guide link generation judgment unit 52 judges whether a guide link, which is a hyperlink to guide the user, should be generated.

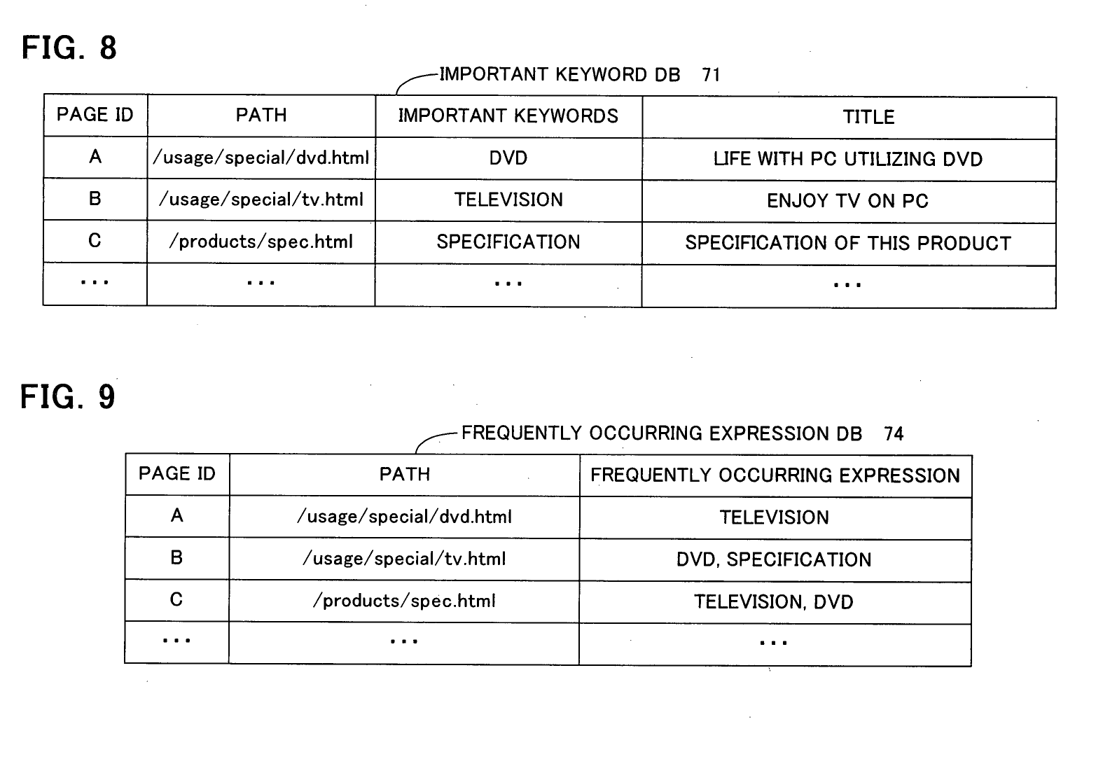

The guide link generation judgment unit 52 compares, for each web page identified by a page ID, the “important keywords” (explained below using FIG. 8) of the important keyword DB and the “search expressions/number of occurrences” (see FIG. 7) of the totaled result DB, and extracts the uppermost two terms with the greatest number of occurrences that are not important keywords for the web page. Then, a judgment is performed referring to the important keyword DB to determine whether to set the two extracted terms as important keywords for another web page, and terms set as important keywords for other web pages are stored in the frequently occurring expression DB 74, in association with the web page file.

The expressions used in the judgment by the guide link generation judgment unit 52 need not be the two most frequently occurring terms. All the expressions included in the “search expression” in the totaled result DB 73 may be used in the judgment. Or, only those search expressions the number of occurrences of which exceeds a prescribed threshold (for example, 500 occurrences) may be used in the judgment.

FIG. 8 is an example of the data configuration of an important keyword DB 71 of this aspect, in which important keywords are associated for each web page. Important keywords are set for each web page, and are stored in advance in the link generation device 2. The important keyword DB of FIG. 8 has the data fields “page ID”, “path”, “important keywords”, and “title”.

The “page ID” is an identifier which uniquely identifies a web page, using alphanumeric characters and symbols. The “path” is address information indicating the storage location of the web page file corresponding to a web page. The “title” is a title which briefly explains the contents of a web page.

“Important keywords” are the important keywords for a web page. An important keyword is a term or expression which characterizes the contents of a web page; the expression is associated with a web page which the web site administrator wants a user to view when the expression is input as a search expression at a search engine site. For example, for the web page with the page ID “A” in FIG. 8, this indicates that the web site administrator wants a user to view this page when when the user inputs “DVD” at a search engine site.

FIG. 9 is an example of the data configuration of a frequently occurring expression DB in this aspect. The frequently occurring expression DB in FIG. 9 has the data fields “page ID”, “path”, and “frequently occurring expression”. “Page ID” is an identifier which uniquely identifies a web page, using alphanumeric characters and symbols. “Path” is address information indicating the storage location of the web page file corresponding to a web page.

A “frequently occurring expression” is, as explained above, an expression other than the important keywords for the page which, among the search expressions used to access the web page, satisfies prescribed conditions (for example, being one of the two most frequently occurring expressions), and which moreover is set as an important keyword for another web page.

For example, in the example of FIG. 7 and FIG. 8, an important keyword for the web page file with the page ID “A” (/usage/special/dvd.html) is “DVD” (see “important keywords” in FIG. 8), but in accesses via a search engine site, in addition to “DVD”, the expressions “television”, “videorecording” and “creation” are used (see “search expressions/number of occurrences” in FIG. 7).

And, among the two expressions with the highest number of occurrences other than the important keyword “DVD”, “television” is used as an important keyword for the web page file with the page ID “B” (/usage/special/tv.html) (see FIG. 8), and the web site administrator wants the user to view the web page file with page ID “B” when the expression “television” is included in the search expression. Hence in this case, a hyperlink guiding the user to the web page with page ID “B” is added to the web page file with page ID “A”.

Returning to FIG. 4, when the frequently occurring expression DB 74 is updated by the guide link generation judgment unit 52, the link generation unit 53 is notified of this updating, and based on the frequently occurring expression DB 74 and important keyword DB 71, the link generation unit 53 acquires from the web server 1 the web page file corresponding the web page to which a guide link is to be added to guide users, and transmits to the web server 1 the web page file with the guide link added.

The link generation unit 53 references the “frequently occurring expressions” of the frequently occurring expression DB 74, and acquires the paths of the web pages for which the expressions stored therein are set as important keywords, referencing the important keyword DB 71 (FIG. 8). For example, in the case of FIG. 9, the term “television”, which is a “frequently occurring expression” for the web page file with page ID “A”, is seen from FIG. 8 to be an important keyword of the web page file with page ID “B”, so that referencing the “path” in FIG. 8, /usage/special/tv.html is obtained. The link generation unit 53 transmits to the web server 1 a file acquisition request for the web page file to which a guide link is to be added, the page ID of which is “A”, and adds a hyperlink guiding the user to the web page with page ID “B” (/usage/special/tv.html) to that web page file.

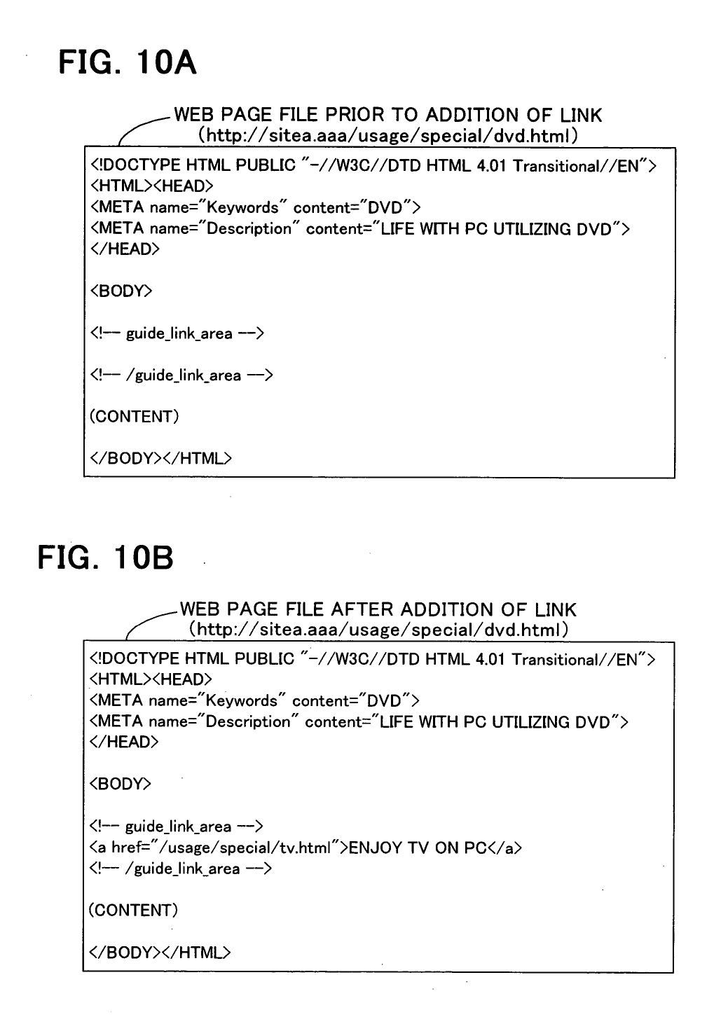

FIG. 10A shows an example of a web page file prior to addition of a link, and FIG. 10B shows an example of a web page file after addition of a link. In FIG. 10, A is the web page file prior to addition of the link. In this aspect, as signs to indicate delimitation of an area in which a guide link has been added, <!--guide_link_area--> and <!--/guide_link_area--> are prepared as comment tags for web browsers.

FIG. 10B is the web page file after link addition; it is seen than an <a href> tag has been used to add a hyperlink to the web page file with page ID “B” (/usage/special/tv.html) in the area in which guide links are to be placed, enclosed between <!--guide_link_area--> and <!--/guide_link_area-->. As the link title (the title when the hyperlink is displayed in a web browser), the character string obtained by referencing “title” in the important keyword DB 71 is used, and is enclosed between <a> and </a>.

That is, based on the path and title of the hyperlink to be added, the link generation unit 53 generates a hyperlink using the <a href> tag, then analyzes the acquired web page file, and places the guide link to be added in the area enclosed by <!--guide_link_area--> and <!--/guide_link_area-->, to generate a web page file with a guide link added.

The link generation unit 53 then transmits the web page file with guide link added to the web server 1, and the web server 1 stores the transmitted web page in the storage unit of the web server 1 to update the web page, so that upon subsequent accesses, a web page with guide link added is displayed to users.

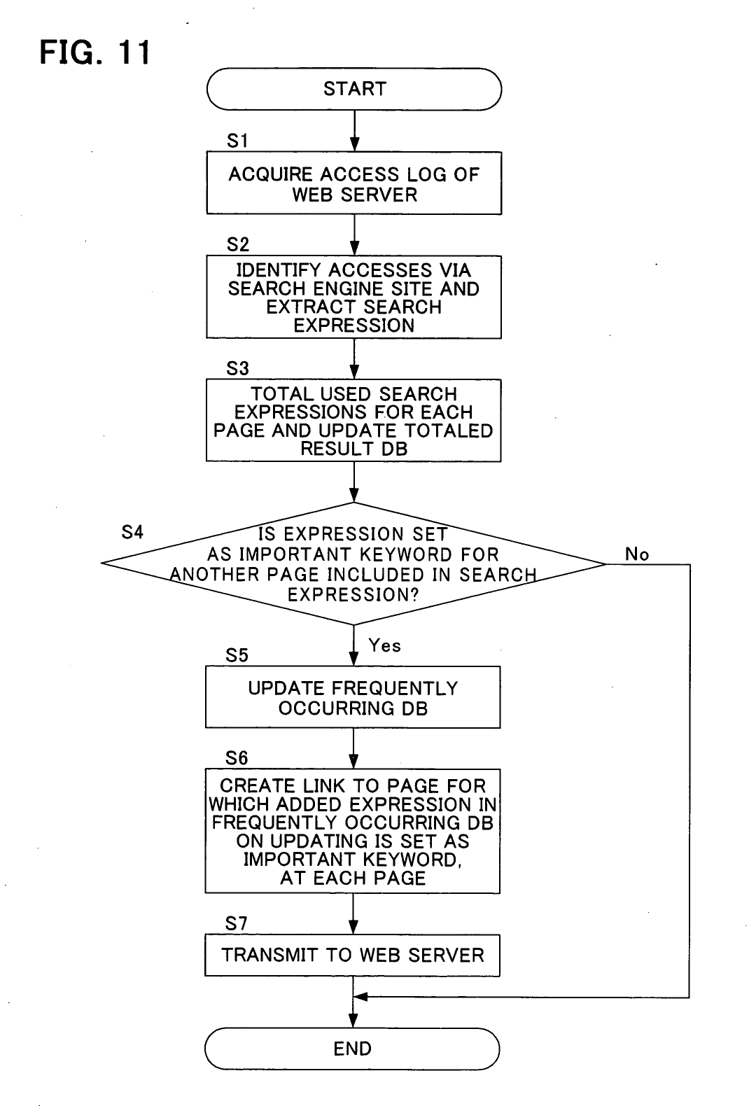

FIG. 11 is a flowchart which explains the operation of the link generation device 2 of this aspect. The important keyword DB 71 and expression extraction information 72 are stored in advance in the storage unit of the link generation device 2.

First, the access log of the web server 1 is acquired by the link generation device 2 (S1). This is performed when the search information extraction unit 51 of the link generation device 2 transmits an access log acquisition request to the web server 1, and the link generation information transmission unit 42 of the web server 1 transmits the access log stored in the access log DB to the link generation device 2.

Next, the link generation device 2 identifies accesses via a search engine site server 3 based on the acquired access log, and extracts search expressions used for each web page (S2). That is, the search information extraction unit 51 of the link generation device 2 searches for access log entries such that a “site address” of the expression extraction information 72 is included in the address information of the referring page 627 in the access log record, and if such an access log record is present, extracts the search expression based on the “search expression location” in the expression extraction information 72.

The link generation device 2 then totals the search expressions used for access of each web page, and updates the totaled result DB 73 (S3). That is, the search information extraction unit 51 of the link generation device 2 totals, for each web page, the search expressions extracted in step S2 and the number of occurrences, and stores the results in the totaled result DB 73.

The link generation device 2 then judges, for each web page, whether an expression set as an important keyword for another web page is included in the search expression (S4). This is performed by the guide link generation judgment unit 52 by comparing, for each web page, the “search expression” stored in the totaled result DB 73 and the “important keywords” stored in the important keyword DB 71.

If, for a certain web page, an “important keyword” of another web page is contained in the “search expression” for the web page being compared (Yes in S4), the guide link generation judgment unit 52 associates the “important keyword” with the web page being compared and updates the frequently occurring expression DB 74 (S5). In step S5, judgment may be performed only for several of the most frequently occurring expressions, based on the number of occurrences in the totaled results. Judgments may also be made only for search expressions the number of occurrences of which exceed a prescribed threshold (for example, 500 occurrences).

If “important keywords” for other web pages are not in the “search expression” of a web page being compared for any of the web pages (No in S4), accessing of web pages is being performed by the input of important keywords at search engine sites by users, and it is judged that access is according to the intentions of the web site administrator, so that the link generation device 2 ends processing without generating guide links.

When updating of the frequently occurring expression DB 74 in step S5 is completed, the link generation device 2 adds, to the web page file being compared, guide links guiding users to web pages corresponding to frequently occurring expressions (S6). First the link generation unit 53 of the link generation device 2 transmits, to the web server 1, a file acquisition request for the web page file corresponding to the “path” in the frequently occurring expression DB, and receives the web page file corresponding to the “path” transmitted by the link generation information transmission unit 42 of the web server 1.

Next, the link generation unit 53 acquires from the important keyword DB 71 the “path” of the web page for which the “frequently occurring expression” of the frequently occurring expression DB 74 is set as an important keyword, and adds a hyperlink to this path (a guide link) to the previously acquired web page file. Addition of the guide link is as explained in FIG. 10.

Finally, the link generation unit 53 of the link generation device 2 transmits the web page file with guide link added to the web server, and processing ends (S7). The update unit 43 of the web server 1 stores the received web page file on the web server 1 to update the web page.

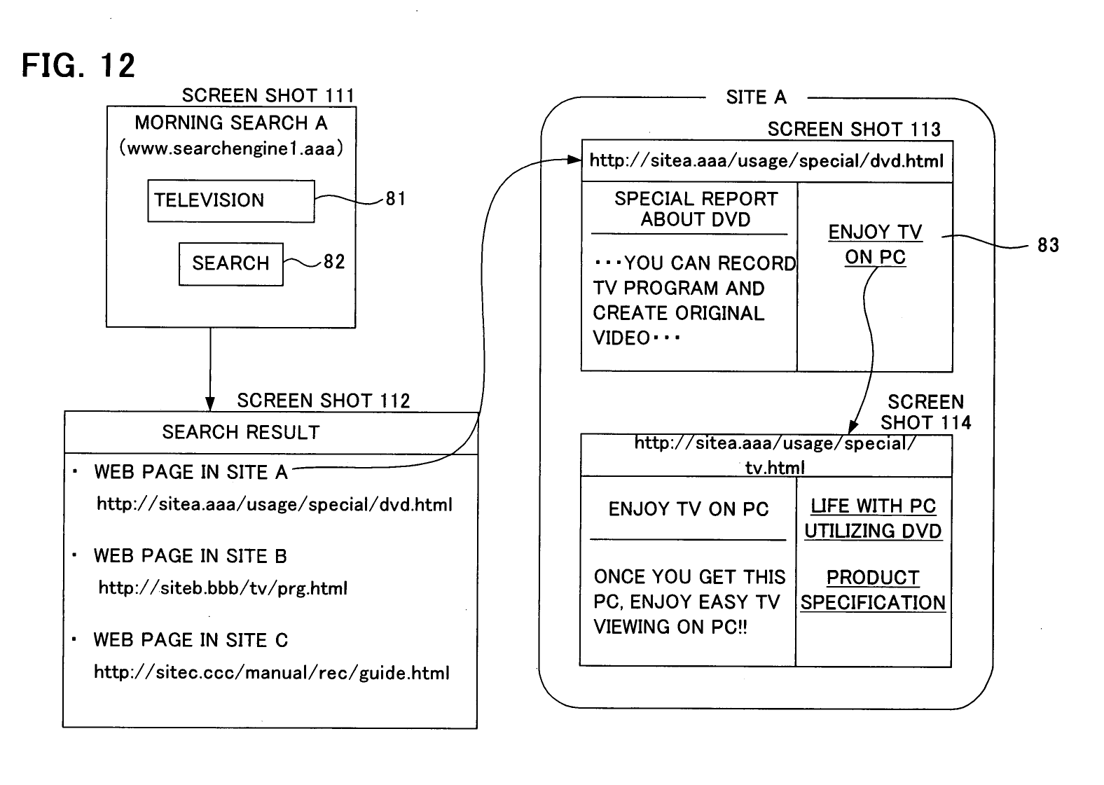

FIG. 12 explains the manner in which a user views a site A constructed on the web server 1 in this aspect, using examples of screens displayed on a client terminal. In FIG. 12, the search engine site server 3 is the search engine site “Morning Search A”, and the site address is www.searchengine1.aaa.

First, a user inputs a search expression to the search engine site server to perform a web site search (screen shot 111). Screen shot 111 depicts the manner in which a user performs a search to obtain information relating to “television” from “Morning Search A” (www.searchengine1.aaa).

The user inputs a search expression into the form field 81 and clicks the search button 82 to execute the search. As the search results, hyperlinks to a plurality of web pages are displayed (screen shot 112). Suppose that the hyperlink displayed at the top, “site A web page”, is clicked.

Then, the web page of site A (http://sitea.aaa/usage/special/dvd.html) is displayed (screen shot 113). Because “DVD” rather than “television” is set as an important keyword for this page (see FIG. 8), this is not a web page that the web site administrator wants the user to view in this case. However, according to this aspect, a hyperlink (“Enjoy TV on PC”) guiding the user to the web page (http://sitea.aaa/usage/special/tv.html) which the administrator wants a user to view upon performing a search using the search expression “television” is added, the user can be appropriately guided to the web page for which an important keyword is “television”. Upon clicking this guide link 83, the user is shown the page at http://sitea.aaa/usage/special/tv.html (screen shot 114).

In this aspect, the link generation device 2 and web server 1 are separate devices connected via a network 5; however, the web server and link generation device may be connected directly by a parallel cable, serial cable, USB, or other signal line.

Also, the link generation device 2 and web server 1 can be realized as a single device (as a web server having link generation functions, or as a link generation device having web server functions). In this case, the search information extraction unit 51 and link generation unit 53 can access web page files and access logs without passing through a network 5, so that in the functional block diagram of FIG. 4 the link generation information transmission unit 42 and update unit 43 can be omitted.

In this aspect, important keywords must be set by a web site administrator or by an operator of the link generation device 2 to reflect the contents of web pages; but automation by the link generation device 2 is also possible. One example is a method which uses the <meta> tag. As a rule for automation, for example, important keywords may be the values of content corresponding to name=“Keywords” in a <meta> tag.

If the link generation device 2 periodically acquires web pages from the web server 1 and performs analysis of the web page files according to the above rule, then extraction of important keywords can easily be performed. Similarly, if a rule is adopted that the “title” data field of the important keyword DB of FIG. 8 is the value of the content corresponding to name=“Description” in a <meta> tag, then the important keyword DB 71 can easily be constructed. An example of actual use can be seen in A of FIG. 10.

As explained above, according to this aspect a hyperlink guiding the user to a web page which the web site administrator wants the user to view when a certain search expression is input at a web search engine site is added to a web page which is frequently accessed by means of the search expression, which is different from the important keywords set for the web page; hence a user accessing the web site can be guided to the web page intended by the web site administrator, without performing authentication processing or other identification of users accessing the web site. Because there is no need to identify users, the log recording functions of the web server can be utilized without modification, and a link generation device 2 can be easily introduced. Because the functions of a link generation device 2 can also be realized as a program, such the program can be installed in a web server 1 to execute link generation function in a single device, thereby reducing costs and administrative tasks.

What is claimed is:

1. A link generation device, which generates link locations of information sought by users, having:
a search information extraction unit, which extracts search information from search operation information which records search operations performed by users;
a guide link generation judgment unit, which judges whether a new link location can be generated, based on said search information; and
a link generation unit, which, when said guide link generation judgment unit judges that a new link location can be generated, generates the new link location.

2. The link generation device according to claim 1,
wherein said search information extraction unit stores the history of said search information, and said guide link generation judgment unit performs said judgment based on said search information history.

3. The link generation device according to claim 1,
wherein said search information extraction unit stores the number of occurrences of said search information received with page acquisition requests to web server, and said guide link generation judgment unit uses, in said judgment, the search information said number of occurrences of which exceeds a prescribed threshold.

4. The link generation device according to claim 1,
wherein said guide link generation judgment unit performs said judgment based on tags embedded in information stored at link locations.

5. The link generation device according to claim 1,
wherein said search operation information is an access log generated by a search device.

6. An information generation device, which generates information specified by users, having:
a search information extraction unit, which extracts search information from search operation information which records search operations performed by users;
a guide link generation judgment unit, which judges whether a new link location can be generated, based on said search information; and,
a link generation unit, which, when said guide link generation judgment unit judges that a new link location can be generated, generates the new link location.

7. The information generation device according to claim 6,
wherein said search information extraction unit stores the history of said search information, and said guide link generation judgment unit performs said judgment based on said search information history.

8. The information generation device according to claim 6,
wherein said search information extraction unit stores the number of occurrences of said search information received with page acquisition requests to said information generation device, and said guide link generation judgment unit uses, in said judgment, the search information said number of occurrences of which exceeds a prescribed threshold.

9. The information generation device according to claim 6, wherein said guide link generation judgment unit performs said judgment based on tags embedded in information stored at link locations.

10. The information generation device according to claim 6, wherein said search operation information is an access log generated by a search device.

11. The information generation device according to claim 6,
further having a communication unit connected to a communication network, and
wherein communication via the communication network is performed.

12. A storage medium having a program which causes a computer to execute:
extracting search information from search operation information which records search operations performed by users;
judging whether a new link location can be generated, based on said search information; and
generating the new link location when in said judgment it is judged that a new link location can be generated.

13. The storage medium according to claim 12,
wherein said program further causes to a computer to execute: storing the history of said search information, and
wherein said judgment is performed based on said search information history.

14. The storage medium according to claim 12,
wherein said program further causes to a computer to execute storing the number of occurrences of said search information received with page acquisition requests to a web server, and
wherein in said judgment, the search information said number of occurrences of which exceeds a prescribed threshold is used.

15. The storage medium according to claim 12,
wherein said judgment is performed based on tags embedded in the information stored at link locations.

16. The storage medium according to claim 12,
wherein said search operation information is an access log generated by a search device.

17. A link generation method of generating link locations of information sought by users, having:
extracting search information from search operation information which records search operations performed by users;
judging whether a new link location can be generated, based on said search information; and
generating the new link location when in said judgment it is judged that a new link location can be generated.

18. The link generation method according to claim 17,
further having: storing the history of said search information, and
wherein said judgment is performed based on said search information history.

19. The link generation method according to claim 17,
further having: storing the number of occurrences of said search information received with page acquisition requests to a web server, and
wherein in said judgment, the search information said number of occurrences of which exceeds a prescribed threshold is used.

20. The link generation method according to claim 17,
wherein said judgment is performed based on tags embedded in the information stored at link locations.

21. The link generation method according to claim 17,
wherein said search operation information is an access log generated by a search device.
